(19) United States
(12) Patent Application Publication
(10) Pub. No.: US 2012/0036089 A1
(43) Pub. Date: Feb. 9, 2012

(54) System and Method for Dynamic, Real-Time Data Management and Processing to Facilitate Business Decisions

(75) Inventors: Steven M. Washington, Rosedale, MD (US); Raja S. Kolluru, Laurel, MD (US)

(73) Assignee: Sentrana, Inc., Washington, DC (US)

(21) Appl. No.: 13/204,144

(22) Filed: Aug. 5, 2011

Related U.S. Application Data
(60) Provisional application No. 61/371,045, filed on Aug. 5, 2010.

(51) Int. Cl. G06Q 30/00

(52) U.S. Cl. 705/400

(57) ABSTRACT

A system and method for integrating pricing components in real-time includes synthesizing a pricing formula obtained by eliciting relevant information from a user. The system and method may associate the pricing formula with identifiers representative of condition tables recognizable to an ERP pricing engine module such as, for example, an SAP pricing engine module or any other similar ERP component. The system and method may also associate coefficients, at least one surcharge, and at least one discount with an identifier representative of a condition type and transmitting/sending the coefficients, at least one surcharge and at least one discount via corresponding datastreams to the ERP pricing engine module.

### CROSS-REFERENCE TO RELATED APPLICATION

This application claims the benefit of the following provisional application, which is hereby incorporated by reference in its entirety: U.S. Provisional Patent Application No. 61/371,045 filed Aug. 5, 2010 titled “System and Method for Dynamic, Real-Time Data Management and Processing to Facilitate Business Decisions.”

### BACKGROUND OF THE INVENTION

1. Field of the Invention

The present invention relates to pricing formulas and, more particularly, to integrating pricing components of the pricing formula into a pricing subsystem of an enterprise resource planning (ERP) system.

2. Description of Related Art

An ERP system is an integrated information system that serves all departments within an enterprise. Evolving out of the manufacturing industry, ERP implies the use of packaged software, rather than proprietary software written by or for one customer. ERP modules may be able to interface with an organization's own software with varying degrees of effort and levels of integration, and, depending on the software, ERP modules may be alterable via the vendor's proprietary tools as well as proprietary or standard programming languages.

An ERP system may include software having a plurality of modules for manufacturing, order entry, accounts receivable and payable, general ledger, purchasing, warehousing, transportation and human resources. Moreover, the ERP system may include a pricing module which may be configured to process pricing formulas for a variety of purposes. One of the largest ERP system vendors is SAP which includes a pricing module that may be configured to process a pricing formula for a particular purpose. As is known in the art, the pricing formula may be represented as a coefficient times the cost of the goods sold plus at least one surcharge and less at least one discount. It is to be understood that pricing formulas are not required to have a discount or surcharge associated with them. The pricing formula may also be created via third-party software and may include or be subjected to a business rule (could be a formula) that is created by a skilled individual, such as a pricing analyst. Business rules take into account, for example, pricing requirements with respect to a customer, an item, and a geographical area. For customers for whom there are price contracts or agreements in place, the use of business rules is generally the only practical pricing option available. A pricing formula may instead be a scientific formula derived by mathematical models within the third-party software. The scientific formula may create prices that lead to a higher probability of improving performance based on a given metric or a business objective, either tactical or strategic in nature. For those customers who are not under contract, the use of a scientific formula would be the preferable pricing method. These two types of rules offer a powerful advantage to a business by helping them to honor contracts and take advantage of pricing opportunities as prices and demands are generally closely correlated.

As is known in the art, the pricing module of ERP systems, such as those in SAP, may utilize condition types and condition tables that are accessed by a price execution engine when a sales order is placed in the ERP system. Currently, the condition types and condition tables must be manually added or edited within a database of the ERP system pricing module such as, for example, an SAP pricing module to address new pricing formulas or changes made thereto. Thus, in any operational setting, this currently requires the on-going services of an ERP system qualified professional such as, for example, an SAP-qualified professional, as modification of condition types and condition tables is technically challenging. This human element and requirement to manually update a database prevents the pricing module from operating in a real-time integrated design context.

It is, therefore, desirable to overcome the above problems and others by providing a system and method for integrating pricing components in real-time, whereby a pricing formula (obtained by eliciting relevant information from a user and/or interrogating a system of records from an ERP system) is synthesized into condition types and condition tables recognizable to an SAP pricing module or similar ERP component and is uploaded via corresponding datastreams to the pricing module.

### SUMMARY OF THE INVENTION

Accordingly, the present invention allows for a pricing formula to be synthesized into an expression (containing the price components and associated coefficients) which is then represented as a combination of condition types that are inherent to the pricing procedure in SAP. Because of being able to address SAP modules via custom programming, custom code can be written to allow the price components to be sent to the SAP pricing module. For example, in one embodiment of the present invention, as illustrated in the logic flow of FIG. 3a, a method is disclosed for associating and integrating price components into a pricing subsystem of an enterprise resource planning system for execution by a pricing engine of the pricing subsystem, the method includes the steps of (a) receiving a first input including pricing requirements corresponding to goods sold, wherein the first input is incompatible with the pricing subsystem (step 300); (b) receiving a second input including at least one cost data (step 302); (c) receiving transaction data (step 304) corresponding to at least one dynamic market value affecting price of the goods sold; (d) determining at least one coefficient based on the transaction data (step 306); (e) converting the pricing requirements into at least one surcharge and at least one discount (step 308); (f) deriving a pricing formula for calculating a price at the time of execution of the pricing formula, wherein the pricing formula comprises the coefficient times a determined cost, plus the at least one surcharge, and less the at least one discount (step 310); (g) associating the pricing formula with a first identifier representative of a condition table in the pricing subsystem (step 312); (h) associating the coefficient, the at least one surcharge, and the at least one discount with a second identifier representative of a condition type in the pricing subsystem (step 314); (i) creating price determination data and cost determination data (step 316); and (j) transmitting the cost determination data and the price determination data to the enterprise resource planning system for storage within a database associated with the enterprise resource planning system (step 318), wherein the steps of (a)-(j) are performed by a stand alone computer or networked computers.

Optionally, the above method, as illustrated in the optional, but desirable logic flow of FIG. 3b, may further include the steps of calculating the determined cost based on the cost data and the cost determination data stored within the database associated with the enterprise resource planning system (step 330); transmitting a determined cost datastream to the pricing subsystem (step 332); transforming the price determination data into a price formula datastream (step 334); and transmitting the price formula datastream to the pricing subsystem (step 336).

Optionally, the above method, as illustrated in the optional logic flow of FIG. 3c, may include the steps of executing, in real-time, the pricing formula based on the price determination data and a determined cost when an order is created in the enterprise resource planning system (step 340); calculating a price based on the pricing formula and the determined cost (step 342); and outputting the calculated price for use by a user as the amount to charge a customer of the user for the goods sold (step 344).

The price determination data contains data corresponding to a (i) predetermined identifiers representative of the condition table and the condition types, and (ii) the values associated with each of the condition types. The determined cost datastream contains data corresponding to at least one determined cost. A corresponding condition table in a database associated with the pricing system is then populated with at least a portion of the data of the price determination data where the first identifier representative of the condition table in the above method may be the same for the coefficient, the at least one surcharge, and the at least one discount. The price determination data may also include new condition types.

The present invention also encompasses a system for associating and integrating price components into a pricing subsystem of an enterprise resource planning system for execution by a price execution engine of the pricing subsystem, wherein the system is configured to implement the method discussed above and computer-readable storage medium storing computer-executable instructions that, when executed, cause a computer system to perform the above method for associating and integrating price components into a pricing subsystem of an enterprise resource planning system for execution by a pricing engine of the pricing subsystem.

By integrating pricing components in real-time, the present invention provides for price flexibility (ERP systems, such as, for example, an SAP is able to execute the pricing formula at the time of order through formulas rather than pre-determined static prices), price accuracy (prices are calculated using the most up-to-date parameter values for scientific model coefficients or cost-plus pricing rule coefficient inside the ERP system), formula flexibility (pricing analysts are able to modify a pricing formula in third-party software as the situation dictates and have modifications be immediately reflected in the ERP system), and system performance (the calculation and retrieval of prices in the ERP system shouldn't hinder the inherent optimal performance of the ERP system such as, for example, systems of SAP).

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic depicting a system framework of the integration aspect of the present invention, according to one embodiment of the present invention;

FIG. 2a illustrates the constituent price components of a pricing formula;

FIG. 2b illustrates an exemplary layout corresponding to the database records structure in an ERP system, such as, for example, an SAP, the condition table and condition types corresponding to the price components of the pricing formula in FIG. 2a;

FIG. 3a illustrates a logic flow for associating a pricing formula with condition tables and condition types of a pricing subsystem of an ERP system;

FIG. 3b illustrates an optional, but desirable logic flow for integrating price components into a pricing subsystem of an ERP system;

FIG. 3c illustrates an optional logic flow for calculating and outputting a price by a pricing subsystem of an ERP system; and

FIG. 4 illustrates an exemplary embodiment of a computer system used in the present invention.

### DETAILED DESCRIPTION OF THE INVENTION

The present invention will now be described with reference to the accompanying figures. It is to be understood that the embodiments illustrated in the figures and described in the following specification are simply exemplary embodiments of the present invention which may be practiced without these specific details. In other instances, well-known operations, components and/or circuits have not been described in detail so as not to obscure the embodiments. It can be appreciated that the specific structural and functional details disclosed herein may be representative and do not necessarily limit the scope of the embodiments.

References throughout the specification to “various embodiments,” “some embodiments,” “one embodiment,” or “an embodiment” mean that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures, or characteristics may be combined in any suitable manner in one or more embodiments.

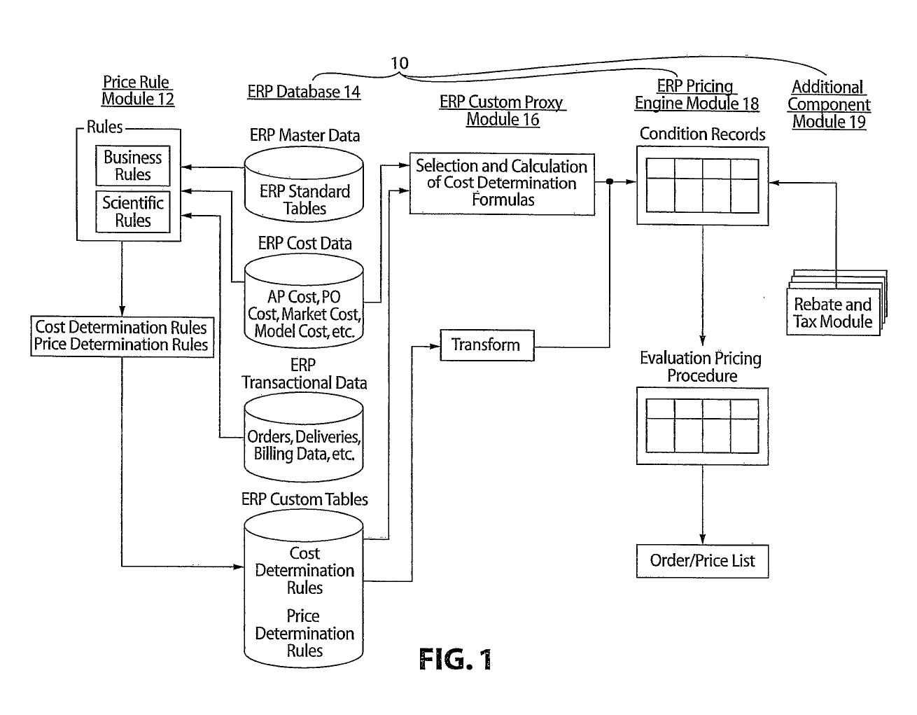

FIG. 1 depicts an embodiment of a system framework of the integration aspect of the present invention. Although FIG. 1 may show a limited number of components, it will be appreciated by those skilled in the art that a greater or fewer numbers of components may be employed for a given implementation. In a non-limiting exemplary embodiment, the ERP Database 14 may store the ERP Master Data, ERP Cost Data, ERP Transaction Data, and/or ERP Custom Tables for the system framework each in a separate database or within a single database or any other combination thereof. In another non-limiting exemplary embodiment, the Price Rule Module 12, the ERP Custom Proxy Module 16, ERP Pricing Engine Module 18, and/or any other Additional Component Modules 19 may all be implemented in any computer executable code or instructions that may be compiled, interpreted, and/or executed by a processor in a computing platform.

Alternatively, at least some of the modules in may be implemented on one or more computers such as, for example, computers 1300 and 1344, in any combination, where the one or more computers are interconnected in a communications network or communicatively coupled via the internet and/or one or more intranets. In some embodiments where one or more modules are implemented across one or more computers interconnected in the computer network, data may be transferred via a variety of mechanisms known to those skilled in the art. In a non-limiting exemplary embodiment, data transfer may take place via File Transfer Protocol (FTP), Hypertext Transfer Protocol (HTTP), Secure Hypertext Transfer Protocol (HTTPS), Remote Copy (RCP), rsync, Secure Copy (SCP), Secure FTP (SFTP) and the like. In another exemplary embodiment, it will be appreciated by those skilled in the art that the modules may also transfer data and/or call or invoke various functions within and/or between each of the modules via any of the well-known inter-process communication (IPC) mechanisms, such as, for example, by the use of pipes, sockets, message queue, message passing, and/or shared memory, between the modules. Additionally, in some embodiments, some IPC mechanisms, such as, for example, sockets, may also be used to transfer data and/or call or invoke various functions between the modules implemented in one or more computers interconnected by one or more communication networks.

In one embodiment of FIG. 1, the system framework may include a Price Rule Module 12, such as, for example, MarketMover by Sentrana, Inc., and the module may provide Price Determination Data which may include, but is not limited to, a Price Determination Rule and Cost Determination Data which may include, but is not limited to, a Cost Determination Rule. The Price Determination Rule may include pricing components of a linear equation representative of an exemplary pricing formula and one or more coefficients for the pricing formula of a customer and material (Inventory Item) combination. However, it will be understood that the pricing formula and embodiments described herein may not be limited to only a customer and material (Inventory Item) combination, but may also include customer group and material combination, customer hierarchy and material combinations, customer and material group combinations and customer material hierarchy combinations; the combinations are not limited in this context.

In a non-limiting exemplary embodiment, a pricing formula may be in the form of “Price=(Rate)(DeterminedCost)+Surcharge1+Surcharge2−Discount1−Discount2,” wherein the Price is the calculated optimal price for a particular inventory item, the Rate, is a coefficient calculated based at least partially on the ERP Master Data stored in the ERP Database 14, the DeterminedCost is the determined cost for the particular inventory item calculated and/or determined by the ERP Custom Proxy Module 16, and the one or more factors, e.g., Surcharge1, Surcharge2, Discount1, Discount2 may be those which affect the price of the particular inventory item, such as, for example, freight costs and tax discounts. However, it is to be understood that not all pricing formulas (e.g., those that are not based on scientific rules) require a multiplication of determined cost. The Cost Determination Rule may include, but is not limited to, indicators and/or flags for choosing and/or selecting a Cost Determination Formula used by the ERP Custom Proxy Module 16 to output a determined cost which may be used by the ERP Pricing Engine Module 18 in calculation of prices using the pricing formula. The Price Rule Module 12 may retrieve, access, and/or read the ERP Master data, ERP Cost Data, and/or the ERP Transactional data from the ERP Database 14, and calculate or determine based at least partially on the ERP Master Data, ERP Cost Data, and/or the ERP Transactional data to store, save, and/or archive the Price Determination Data and the Cost Determination Data for a particular Customer and Material (Inventory Item) combination in the ERP Custom Tables of the ERP Database 14. The ERP Proxy Module 16 may then use the Price Determination Rule stored in the Cost Determination Data and Cost Determination Rule stored in the Price Determination data to calculate and/or determine the determined cost and incorporate the determined cost in the pricing formula.

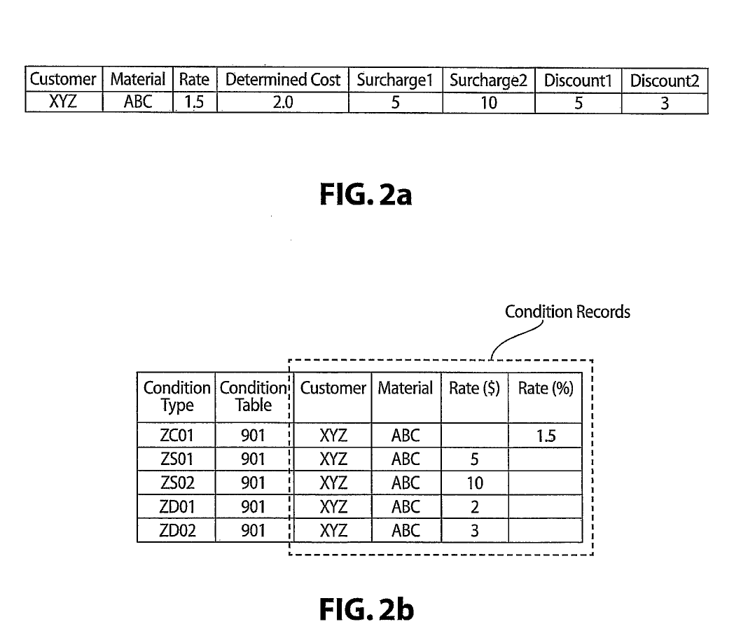

In another embodiment of FIG. 1, the system framework may include an ERP Database 14 (or related databases). The ERP Database 14 may store ERP Master Data which may include, but is not limited to, one or more tables storing customer provided data such as, for example, Cost of the Goods Sold (COGS) one or more factors, such as, for example, fuel costs, freight costs, customer hierarchies, and/or product hierarchies. Additionally, the ERP Database 14 may also store ERP Cost Data, which may include, but is not limited to, Accounts Payable (AP) Cost, Purchase Order (PO) Cost, Market Cost, Model Cost, i.e., a predicted cost calculated by the Price Rule Module, Guaranteed Cost, i.e., a contract cost, and/or any other cost related data for inventory items. Further, the ERP Database 14 may also store ERP Transactional Data corresponding to one or more dynamic market values affecting the goods, which may include, but is not limited to: an order reason; a sales order number; sales order line items; a sales unit; order quantity; invoice quantity; net weight; currency; a sales associate; gross price; cost of goods sold; a purchase order type; freight costs; geographic area and the like. The ERP Database 14 may also be configured to store Customized Tables for holding coefficients of the Price Determination Rules and Cost Determination Rules. A non-limiting exemplary embodiment of the entries within the Customized Tables for a customer material combination is shown in FIG. 2b.

The ERP Database 14 may also store condition records in condition tables and respective condition types that may be transformed and/or translated by the ERP Custom Proxy Module 16 based on the Price Determination Rules and Cost Determination Rules stored in the Custom Tables of ERP Database 14, where each condition table may be associated with one or more respective condition types. Moreover, the ERP Pricing Engine Module 18, such as, for example, an SAP pricing execution engine, may then retrieve, access, and/or read the condition records stored within the ERP Database 14 and execute the pricing formula when a sales order is placed.

In another embodiment of FIG. 1, the system framework may include an ERP Custom Proxy Module 16 which serves as a proxy and/or an interface that allows the pricing components of the pricing formula within a Price Determination Rule to be represented as condition records within associated condition tables and condition types. In a preferred embodiment, the ERP Custom Proxy Module 16 may be coded in a programming language supported by the ERP system 10 such as, for example, Advanced Business Application Programming (ABAP) language in SAP. However, it will be appreciated by those skilled in the art that the ERP Custom Proxy Module 16 may be implemented in any high-level or low-level programming language which may be executed by an interpreter of the ERP system 10 or, alternatively, compiled and linked to various modules of the ERP system 10. The ERP Custom Proxy Module 16 may be configured to read, access, and/or retrieve the Price Determination Data from Custom Tables in the ERP Database 14 and load Price Determination Rules in the Price Determination Data into respective existing condition type and condition tables with respect to the indicators present in the Price Determination Rules. Additionally, the ERP Custom Proxy Module 16 may also be configured to read the Cost Determination Data from the ERP Database 14 and calculate and/or determine a determined cost for a customer and material combination based on the Cost Determination Rules in the Cost Determination Data and ERP Cost Data.

The ERP Custom Proxy Module 16 may be configured to include one or more Cost Determination Formulas and may calculate and/or determine a determined cost to use by the ERP pricing Engine Module 18 for a particular Customer and Material (Inventory Item) combination based at least partially on the indicators and/or flags in the Cost Determination Rule retrieved, read, and/or accessed from the ERP Database 14 and Cost Data such as, for example, AP Cost, PO Cost, Market Cost, Model Cost, and/or Guaranteed Cost retrieved, read, and/or accessed from the ERP Database 14. Moreover, the Custom Tables may be configured to store a Cost Determination Rule including one or more indicator and/or flags for selecting and choosing a particular Cost Determination Formula within the ERP Custom Proxy Module 16 for use with a particular customer and material combination. The ERP Proxy Module 16 may also be configured to execute the selected or chosen Cost Determination Formula on a periodic and/or on demand basis as to consider the latest ERP Cost Data present in the ERP system 10 such as, for example, the latest Cost Data within SAP. After execution of the Cost Determination Formula for a particular customer and material (Inventory Item) combination, the output of the ERP Custom Proxy Module 16, i.e., the determined cost for the particular customer and material (Inventory Item) combination is transferred as determined cost datastream into ERP system 10 to be stored in the ERP Database 14 in an associated condition table and respective condition type for the particular customer and material (Inventory Item) combination in the condition records, such as, for example, SAP condition records. The determined cost may then be used as a basis for which the price components of a pricing formula are executed by the ERP Pricing Engine Module 18 such as, for example, the price engine of SAP. The Price Rule Module 12 may generalize the pricing formulas into a breakup of condition types and condition tables to fit into the condition technique of the ERP system 10, such as, for example, the standard pricing procedure in SAP. In a non-limiting exemplary embodiment, the coefficient, and one or more factors such as surcharge and/or discount would be associated with one particular condition table and the respective condition types of the condition table. Upon a sales order being created, the ERP Pricing Engine Module 18 may retrieve, access, and/or read the condition records containing the coefficients of the pricing formula. In particular, the ERP Pricing Engine Module 18 may retrieve, access, and/or read the condition table and respective condition type corresponding to the coefficient, e.g., the Rate, associated with the determined cost and the determined cost itself, as well as the condition type associated with any surcharges and discounts and calculate, execute, and/or determine the Price in accordance with the pricing formula. Condition types associated with Additional Component Modules 19, such as, for example, Rebate and Tax Solution Modules by Vistex, that may be stored, saved, and/or archived as one or more surcharges and/or discounts in one or more condition records of a condition table and with a respective condition type of the condition table within the ERP Database 14 may also be retrieved, accessed, and/or read and factored into the calculation, execution, and determination of the Price using the pricing formula.

The present invention will now be discussed in further detail below with reference to FIGS. 2a and 2b, and with continuing reference to FIG. 1. Initially, pricing requirements for desired goods are received from a Customer (XYZ) into the Price Rule Module 12. The pricing requirements may include, but are not limited to, business rules used in calculation of a price for customer/material combinations (ABC), a price for customer group/material combinations, a price for customer hierarchy/material combinations, a price for customer/material group combinations, and a price for customer/material hierarchy combinations. The Price Rule Module 12 may include a branching logic query and one or more user interfaces to efficiently elicit the appropriate pricing requirements. However, because the pricing requirements may be received from a customer in a format incompatible with the ERP Pricing Engine Module 18, the received pricing requirements may be synthesized in conjunction with relevant data obtained from the ERP Database 14 to create Price Determination Data which may include, but is not limited to, a Price Determination Rule that includes a pricing formula in the form of pricing components such as the exemplary pricing component illustrated in FIG. 2a formatted and outputted as illustrated in FIG. 2b. The relevant data may include, but is not limited to, relevant cost formulas, ERP Cost Data, and ERP Transactional Data. The Price Rule Module 12 may also create a Cost Determination Data which may include a Cost Determination Rule which may contain one or more flags or indicators for selecting or choosing the cost determination formula is used to calculate and/or determine the determined cost by the ERP Custom Proxy Module 16. Additionally, the Price Rule Module 12 may calculate and/or determine at least one coefficient in the pricing formula based at least partially on the ERP Transactional Data, ERP Cost Data, ERP Master Data stored in ERP Database 14 and/or any other data that may influence the Price of a particular customer and material (Inventory Item) combination. Thereafter, the Price Rule Module 12 may derive the pricing formula for establishing a price at the time of execution of the pricing formula by the ERP Pricing Engine Module 18 and a Cost Determination Rule for use by the ERP Custom Proxy Module 16 to calculate and/or determine a determined cost used in the calculation and/or determination of the Price by the ERP Pricing Engine Module 18. As discussed above, the pricing formula is based on the pricing requirements and is represented as the coefficient (Rate) times the determined cost (DeterminedCost), plus the at least one surcharge (e.g., Surcharge1, Surcharge 2), and less the at least one discount (e.g., Discount1, Discount2). Thus, the corresponding linear equation would be “Price=(Rate) (DeterminedCost)+Surcharge1+Surcharge2−Discount1−Discount2”.

In a non-limiting exemplary embodiment for a Customer and Material (Inventory Item) combination (XYZ and ABC) pricing formula, assume that Rate=1.5; Surcharge1=5; Surcharge2=10; Discount1=2; and Discount2=3. The determined cost (e.g., 2.0) will be retrieved, read, and/or accessed from the ERP Database 14 by the ERP Pricing Engine Module 18 when the ERP Pricing Engine Module 18 calculates and/or determines the Price for XYZ and ABC combination in accordance with the pricing formula. This can be visualized by the table shown in FIG. 2a outlining the constituent price components. After the Price Rule Module 12 calculates and/or determines the pricing formula in the form of pricing components and the flags and/or indicators for selecting or choosing which cost determination formula to use in calculating the determined cost, the Price Rule Module 12 may send and/or transmit the pricing components as Price Determination Data and Cost Determination Data, respectively, for storage and/or archive within the ERP Database 14. A non-limiting exemplary embodiment of the Price Determination Rule transmitted, sent, and/or outputted by the Price Rule Module 12 and stored, saved, and archived within Custom Tables of the ERP Database 14 is illustrated in FIG. 2b. The ERP Custom Proxy Module 16 may then, periodically and/or on demand, read, access, and/or retrieve the Price Determination Data and Cost Determination Data stored in Custom Tables of the ERP Database 14 and calculate and/or determine a determined cost based on the Price Determination Rules, ERP Cost Data and a Cost Determination Formula selected by one or more indicators or flags within Cost Determination Rules. Additionally, ERP Custom Proxy Module 16 may also transform, translate, and/or convert the Price Determination Rules stored in the Custom Tables within the ERP Database 14 into respective Condition Records stored in Condition Tables and the respective Condition Types of the Condition Tables. The ERP Custom Proxy Module 16 may transform, translate, and/or convert the Price Determination Rule by mapping the price components to condition records stored in condition tables existing in the ERP system 10, such as, for example, condition tables in SAP. The Price Rule Module 12 may be configured or programmed to have an understanding of the condition records including the condition types and condition tables that already exist in ERP system 10 such as, for example, the condition records stored in condition tables, and with respective condition tables existing in SAP. Continuing with the above non-limiting exemplary embodiment, assume that the corresponding condition table for the aforementioned customer/material combination is 901. Also assume that the condition types are as follows: Rate is ZC01; Surcharge1 is ZS01; Surcharge2 is ZS02; Discount1 is ZD01; and Discount2 is ZD02. Thus, the pricing formula is associated with the corresponding, predetermined identifier representative of a condition table in the pricing subsystem and the coefficients, the surcharges, and the discounts are associated with respective, corresponding, predetermined identifiers, e.g., ZC01, ZS01, ZS02, ZD01, and ZD02 representative of a condition type in the ERP Pricing Engine Module 18. Thereafter, a price formula datastream and a determined cost datastream may be created by the ERP Custom Proxy Module 16 that allows the ERP Pricing Engine Module 18 to understand the price coefficients, surcharges, and discounts. For example, as illustrated in FIG. 2b, the Price Formula Datastream may include, but is not limited to, the Customer, Material, Rate ($), and Rate (%) columns associated with the condition table and condition types in a layout corresponding to the database records structure in the ERP system 10, which makes the data compatible with the ERP system 10 such as, for example, the systems of SAP. Moreover, the database records of the ERP system 10 may use the condition type and condition table columns as keys and/or indexes for searching and/or indexing the particular condition record, e.g., a Customer, Material, Rate ($), and Rate (%) associated with the particular predetermined identifier of the condition table and respective condition type. Accordingly, as shown in FIG. 2b, the Price Formula Datastream may contain data corresponding to (i) the predetermined identifiers representative of the condition table and the condition types and (ii) the values, e.g., Customer, Material, Rate ($), and Rate (%) associated with each of the condition types. The Determined Cost Datastream may contain the determined cost for the particular Material and its predetermined identifiers representative of the condition table and condition type. The Determined Cost Datastream and the Price Formula Datastream are then sent, transferred, and/or transmitted to the ERP Pricing Engine Module 18 via any of the file and/or data transfer mechanisms previously described. It will be understood that the Determine Cost Datastream and the Price Determination Datastream may be calculated on a periodic basis or an on-demand basis i.e., as requested by a user of the ERP system 10 and/or Price Rule Module 12 so that the latest ERP Cost Data and/or pricing components may be used in the calculation of a price by the ERP Pricing Engine Module 18.

After the Datastreams are sent, transferred, and/or transmitted to the ERP Pricing Engine Module 18, the ERP system 10 may save, store, and/or archive the data in the Datastreams into a corresponding condition table in a database associated with the ERP Pricing Engine Module 18. As illustrated in FIG. 2b, the predetermined identifier representative of the condition table (i.e., 901) is the same for the coefficient, the surcharges, and the discounts. Accordingly, when an order is created within the ERP system 10, such as, for example, SAP, the pricing formula may be executed by the ERP Pricing Engine Module 18 in accordance with an evaluation pricing procedure to calculate and/or determine a price for a customer and material combination. The evaluation pricing procedure may, as illustrated with the exemplary layout of the pricing components for a pricing formula shown in FIG. 2a, retrieve, access, and/or read the pricing components of the pricing formula such as, for example, the determined cost, coefficients (e.g., Rate), at least one surcharge (e.g., Surcharge1, Surcharge2), and/or at least one discount (e.g., Discount1, Discount2) stored in condition records and calculate and/or determine a Price or Prices in an Order/Price List for the customer and material combination in accordance with the mathematical operations and/or any other operations of the pricing formula. Moreover in a non-limiting exemplary embodiment, the ERP Pricing Engine Module 18 may search the various tables in the ERP Database 14 based on the order information and retrieve the relevant condition records containing the pricing components. If the order is placed by customer XYZ for material ABC, then the ERP Pricing Engine Module 18 may read, access, and/or retrieve each associated constituent price component as applied within the pricing formula and execute the pricing formula to calculate and/or determine, in real-time, an optimal price for customer XYZ and material ABC combination. The calculated optimal price may then be outputted to a display device coupled to the ERP system 10 viewable by a user of the ERP system 10 or the user's customer, such as, for example, customer XYZ. Alternatively, the calculated optimal price may be stored, saved, and/or archived within the database associated with the ERP system 10. The calculated price, regardless of whether it is outputted to the display device or stored in the database, may then be used by the users of the ERP system 10 and/or Pricing Rule Module 12 as the amount to charge the user's customers, such as, for example customer XYZ, when customer XYZ purchases the inventory item or material ABC.

Unless specifically stated otherwise, it may be appreciated that terms such as “converting” “deriving” “transforming,” “processing,” “computing,” “calculating,” “determining,” “providing,” “updating,” or the like refer to the action and/or processes of a computer or computing system, or similar electronic computing device, that manipulates and/or transforms data represented as physical quantities (e.g., electronic) within registers and/or memories into other data similarly represented as physical quantities within the memories, registers, or other such information storage, transmission, or display devices.

At least one of the figures includes a flow diagram. Although these figures may include a particular logic flow, it can be appreciated that the logic flow merely provides an exemplary implementation of the general functionality. Further, the logic flow does not necessarily have to be executed in the order presented unless otherwise indicated. It also can be appreciated that while a logic flow may illustrate a certain sequence of steps, other sequences of steps may also be performed according to alternative embodiments. Moreover, some individual steps of a logic flow may include multiple sub-steps that may be performed in various sequences as appropriate to the individual step. Furthermore, additional steps may be added or some steps may be removed depending on the particular implementation.

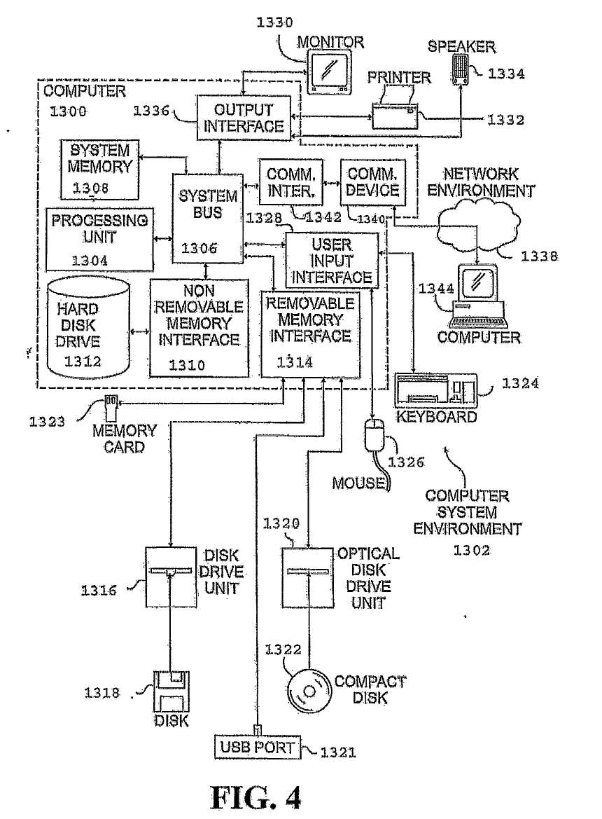

Accordingly, the present invention may be embodied in software operating on communicatively connected hardware components such as, for example, computers 1300 and/or 1344 of FIG. 4, which may or may not be inherent to any particular ERP system 10 architecture such as, for example, an SAP architecture. Such hardware components, on which the methods and systems described herein are deployed in part or in whole, may be configured to execute computer software program codes and/or instructions via a processor or processing unit 1304 thereof where the computer software program codes may be embodied in one or more modules stored in system memory 1308, hard disk drive 1312, non-removal memory interface 1310, and/or removable memory interface 1314. As previously described, the processor or processing unit 1304 may be part of a server, client, network infrastructure, mobile computing platform, stationary computing platform, or other computing platform. The processor or processing unit 1304 may be communicatively connected or coupled to the Internet or any other distributed communications network via a wired or wireless interface. The processor or processing unit 1304 may be any kind of computational or processing device capable of executing program instructions, codes, binary instructions, and the like. The processor may be or include a signal processor, digital processor, embedded processor, microprocessor, graphics processor, or any variant such as a co-processor (math co-processor, graphic co-processor, in-memory processor, communication co-processor, cloud-computing, and the like), and the like that may directly or indirectly facilitate execution of program code or program instructions stored thereon. In addition, the processor or processing unit 1304 may enable execution of multiple modules, programs, threads, and codes. The threads may be executed simultaneously to enhance the performance of the processor and to facilitate simultaneous operations of the application. The processor or processing unit 1304 may include and/or be coupled to memory that stores modules, methods, codes, instructions, and programs as described herein and elsewhere. The processor may access a storage medium through an interface that may store modules, methods, codes, and instructions as described herein and elsewhere. The storage medium associated with the processor for storing methods, programs, codes, program instructions, or other type of instructions capable of being executed by the computing or processing device may include, but may not be limited to, one or more of a CD-ROM, DVD, memory, hard disk, flash drive, RAM, ROM, cache, and the like.

FIG. 4 illustrates exemplary personal computers 1300, 1344 included in a computing system environment 1302 which may be used in the present invention. This computing system environment 1302 may include, but is not limited to, at least one computer 1300 having certain components for appropriate operation, execution of computer software program code or instructions embodied in one or more modules such as, for example, the Pricing Rule Module 12, and creation and communication of data. For example, the computer 1300 includes the processor or the processing unit 1304 (typically referred to as a central processing unit or CPU) that serves to execute computer-based instructions received in the appropriate data form and format. Further, this processor or processing unit 1304 may be in the form of multiple processors executing code in series, in parallel, or in any other manner for appropriate implementation of the computer-based instructions.

In order to facilitate appropriate data communication and processing information between the various components of the computer 1300, a system bus 1306 is utilized. The system bus 1306 may be any of several types of bus structures, including a memory bus or memory controller, a peripheral bus, or a local bus using any of a variety of bus architectures. In particular, the system bus 1306 facilitates data and information communication between the various components (whether internal or external to the computer 1300) through a variety of interfaces, as discussed hereinafter.

The computer 1300 may include a variety of discrete computer-readable media components. For example, this computer-readable media may include any media that can be accessed by the computer 1300, such as volatile media, non-volatile media, removable media, non-removable media, etc. As a further example, this computer-readable media may include computer storage media, such as media implemented in any method or technology for storage of information, such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 1300. Further, this computer-readable storage medium may include communications media, such as computer-readable instructions, data structures, program modules, or other data in a modulated data signal, such as a carrier wave or other transport mechanism and include any information delivery media, wired media (such as a wired network and a direct-wired connection), and wireless media (such as acoustic signals, radio frequency signals, optical signals, infrared signals, biometric signals, bar code signals, etc.). Of course, combinations of any of the above should also be included within the scope of computer-readable media.

The computer 1300 may further include a system memory 1308 with computer storage media in the form of volatile and non-volatile memory, such as ROM and RAM. A basic input/output system (BIOS) with appropriate computer-based routines assists in transferring information between components within the computer 1300 and is normally stored in ROM. The RAM portion of the system memory 1308 typically contains data and program modules that are immediately accessible to or presently being operated on by processing unit 1304, e.g., an operating system, application programming interfaces, application programs, program modules, program data, and other instruction-based computer-readable codes.

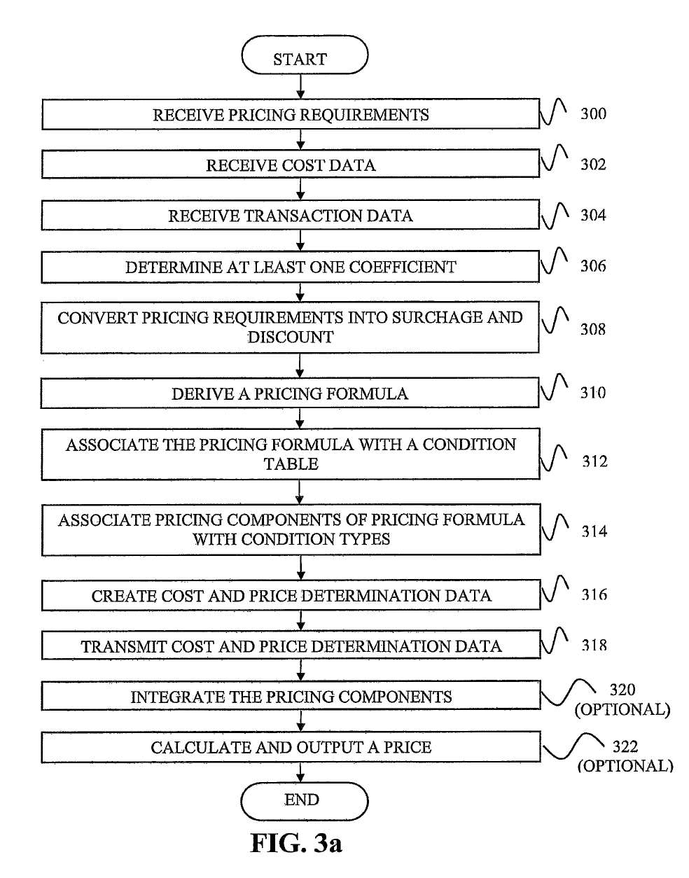

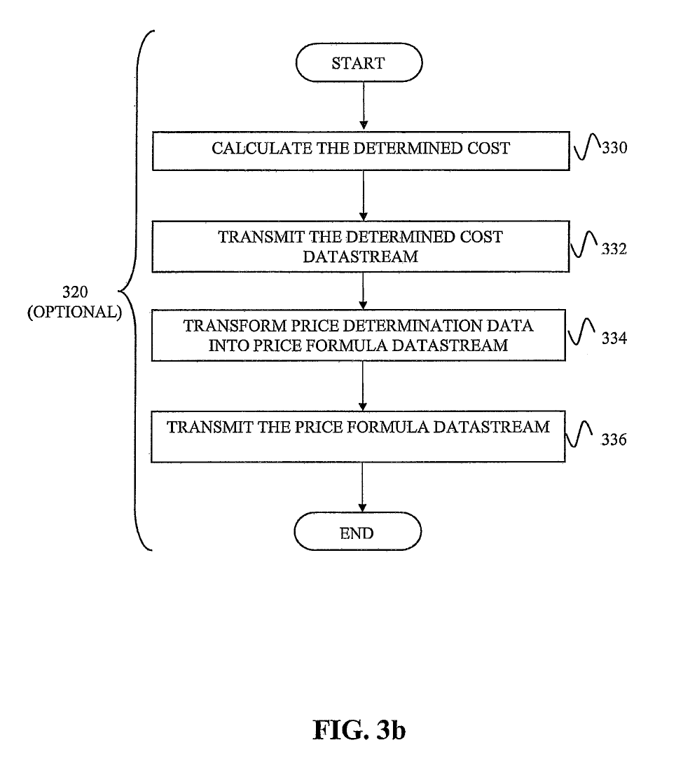

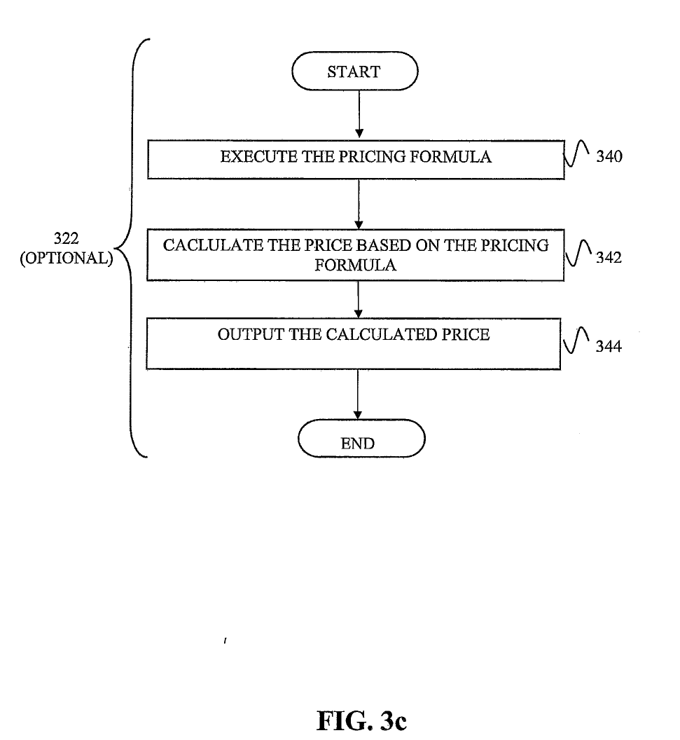

With continued reference to FIG. 4, the computer 1300 may also include other removable or non-removable, volatile or non-volatile computer storage media products. For example, the computer 1300 may include a non-removable memory interface 1310 that communicates with and controls a hard disk drive 1312, i.e., a non-removable, non-volatile magnetic medium; and a removable, non-volatile memory interface 1314 that communicates with and controls a magnetic disk drive unit 1316 (which reads from and writes to a removable, non-volatile magnetic disk 1318), an optical disk drive unit 1320 (which reads from and writes to a removable, non-volatile compact disk 1322, such as a CD ROM), a Universal Serial Bus (USB) port 1321 for use in connection with a removable memory card, etc. However, it is envisioned that other removable or non-removable, volatile or non-volatile computer storage media can be used in the exemplary computer system environment 1302, including, but is not limited to, magnetic tape cassettes, DVDs, digital video tape, solid state RAM, solid state ROM, etc. These various removable or non-removable, volatile or non-volatile magnetic media are in communication with the processing unit 1304 and other components of the computer 1300 via the system bus 1306. The drives and their associated computer storage media discussed above and illustrated in FIG. 3 provide storage of operating systems, computer-readable instructions, application programs, data structures, program modules, program data and other instruction-based computer-readable code for the computer 1300 (whether duplicative or not of this information and data in the system memory 1308).

A user may enter commands, information, and data into the computer 1300 through certain attachable or operable input devices, such as a keyboard 1324, a mouse 1326, etc., via a user input interface 1328. Of course, a variety of such input devices may be utilized, e.g., a microphone, a trackball, a joystick, a touchpad, a touch-screen, a scanner, etc., including any arrangement that facilitates the input of data and information to the computer 1300 from an outside source. As discussed, these and other input devices are often connected to the processing unit 1304 through the user input interface 1328 coupled to the system bus 1306, but may be connected by other interface and bus structures, such as a parallel port, game port, or a universal serial bus (USB). Still further, data and information can be presented or provided to a user in an intelligible form or format through certain output devices, such as a monitor 1330 (to visually display this information and data in electronic form), a printer 1332 (to physically display this information and data in print form), a speaker 1334 (to audibly present this information and data in audible form), etc. All of these devices are in communication with the computer 1300 through an output interface 1336 coupled to the system bus 1306. It is envisioned that any such peripheral output devices be used to provide information and data to the user.

The computer 1300 may operate in a network environment 1338 through the use of a communications device 1340, which is integral to the computer or remote therefrom. This communications device 1340 is operable by and in communication to the other components of the computer 1300 through a communications interface 1342. Using such an arrangement, the computer 1300 may connect with or otherwise communicate with one or more remote computers, such as a remote computer 1344, which may be a personal computer, a server, a router, a network personal computer, a peer device, or other common network nodes, and typically includes many or all of the components described above in connection with the computer 1300. Using appropriate communication devices 1340, e.g., a modem, a network interface or adapter, etc., the computer 1300 may operate within and communicate through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 1300, 1344 may be used.

As used herein, the computer 1300 includes or is operable to execute appropriate custom-designed or conventional software to perform and implement the processing steps of the method and system of the present invention, thereby forming a specialized and particular computing system. Accordingly, the presently-invented method and system may include one or more computers 1300 or similar computing devices having a computer-readable storage medium capable of storing computer-readable program code or instructions that cause the processing unit 1304 to execute, configure, or otherwise implement the methods, processes, and transformational data manipulations discussed hereinafter in connection with the present invention. Still further, the computer 1300 may be in the form of a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

Computer 1344 represents one or more work stations appearing outside the local network which may include one or more computers coupled to the ERP Database 14 and executing ERP Custom Proxy Module 16, the Pricing Engine Module 18, and/or Additional Component Modules 19. One or more users may interact with computer 1300, which can be an exchange system of logically integrated components. In addition, secure exchange of information or data can take place through the Internet using secure World Wide Web. Electronic data interchanges can be transacted through networks connecting computer 1300 and computer 1344 via any of the data transfer mechanisms described herein.

In various embodiments, the present invention or portions of the present invention, for example, the Price Rule Module 12, the ERP Database 14, the ERP Custom Proxy Module 16, the ERP Pricing Engine Module 18, and/or Additional Component Modules 19 may be implemented in a variety of computing devices and systems, wherein these computing devices include the appropriate processing mechanisms and the article and/or the computer-readable storage medium for storing and executing computer-readable instructions, such as programming instructions, code, and the like. In one non-limiting exemplary embodiment, Price Rule Module 12 may be implemented in the computer 1300 running one or more processes, which is communicatively coupled via the appropriate communication devices 1340 across the network environment 1338 to the ERP Database 14, ERP Custom Proxy Module 16, ERP Price Engine Module 18, and/or Additional Component Modules 19 implemented on computer 1344. The Price Formula Module 12 may communicate and/or transfer data to the ERP Database 14, ERP Rule Proxy Module 16, ERP Pricing Engine Module 18, and Additional Component Module 19 implemented on computer 1344 via any of the data transfer mechanisms or IPC mechanisms previously described. It will be appreciated by those skilled in the art, that any combination of modules and computers, which may not be limited to computers 1300 and 1344, may be realized without deviating from the spirit of the present invention.

Additionally, it may be appreciated that the modules, methods, and/or processes described above, and the steps thereof, may be realized in hardware, software, or any combination of hardware and software suitable for a particular application. The hardware may include, but is not limited to, the above described computer 1300 and/or 1344 and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a computer-readable storage medium.

The computer-readable storage medium may comprise one or more types of computer-readable storage media capable of storing data, including volatile memory or non-volatile memory, removable or non-removable memory, erasable or non-erasable memory, writeable or re-writeable memory, and so forth. Additionally, the computer-readable storage medium may be of the non-transitory type. Examples of computer-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferro electric polymer memory), phase-change memory, ovonic memory, ferro electric memory, silicon-oxide-nitride-oxide-silicon (SONOS) memory, magnetic or optical cards, or any other suitable type of computer-readable storage media in accordance with the described embodiments.

The computer executable code embodied in at least one of the modules may be created using a structured programming language such as C, an object oriented programming language such as C++, or any other high-level or low-level programming language (including assembly languages, hardware description languages, and database programming languages and technologies) that may be stored, compiled, or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code within one or more modules that, when executing on one or more computing devices, performs the steps thereof. In another aspect, the methods may be embodied in systems that perform the steps thereof, and may be distributed across devices in a number of ways, or all of the functionality may be integrated into a dedicated, stand-alone device or other hardware. In another aspect, the means for performing the steps associated with the processes described above may include any of the hardware and/or software described above. All such permutations and combinations are intended to fall within the scope of the present disclosure.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment. Furthermore, although some embodiments of the present invention are discussed in the context of an SAP architecture, it is to be understood that the invention may operate on or be adapted for operation on other ERP systems.

The invention claimed is:

1. A method for associating and integrating price components into a pricing subsystem of an enterprise resource planning system for execution by a pricing engine of the pricing subsystem, the method comprising the steps of:
(a) receiving a first input including pricing requirements corresponding to goods sold, wherein the first input is incompatible with the pricing subsystem;
(b) receiving a second input including at least one cost data;
(c) receiving transaction data corresponding to at least one dynamic market value affecting price of the goods sold;
(d) determining at least one coefficient based on the transaction data;
(e) converting the pricing requirements into at least one surcharge and at least one discount;
(f) deriving a pricing formula for calculating a price at the time of execution of the pricing formula, wherein the pricing formula comprises the coefficient times a determined cost, plus the at least one surcharge, and less the at least one discount;
(g) associating the pricing formula with a first identifier representative of a condition table in the pricing subsystem;
(h) associating the coefficient, the at least one surcharge, and the at least one discount with a second identifier representative of a condition type in the pricing subsystem;
(i) creating price determination data and cost determination data; and
(j) transmitting the cost determination data and the price determination data to the enterprise resource planning system for storage within a database associated with the enterprise resource planning system, wherein the steps of (a)-(j) are performed by a standalone computer or networked computers.

2. The method of claim 1, further comprising the steps of:
calculating the determined cost based on the cost data and the cost determination data stored within the database associated with the enterprise resource planning system;
transmitting a determined cost datastream to the pricing subsystem;
transforming the price determination data into a price formula datastream; and
transmitting the price formula datastream to the pricing subsystem.

3. The method of claim 2, further comprising the step of outputting at least one price for use by a user as the amount to charge a customer of the user for the goods sold, wherein the at least one price is calculated based on the price formula datastream and the determined cost datastream.

4. The method of claim 2, further comprising the step of populating a corresponding condition table in a database associated with the pricing system with the data of the price formula datastream, wherein the first identifier representative of the condition table is the same for the coefficient, the at least one surcharge, and the at least one discount.

5. The method of claim 1, further comprising the step of executing, in real-time, the pricing formula based on the price determination data and a determined cost when an order is created in the enterprise resource planning system, wherein the determined cost is calculated based at least partially on the cost determination data.

6. The method of claim 1, wherein the price formula datastream and determined cost datastream are created on an on-demand basis.

7. The method of claim 1, wherein the pricing requirements further include at least one of:
a price for customer/material combinations;
a price for customer group/material combinations;
a price for customer hierarchy/material combinations;
a price for customer/material group combinations; and
a price for customer/material hierarchy combinations.

8. The method of claim 1, wherein the cost determination data and the price determination data are created on a periodic basis.

9. The method of claim 5, further comprising the step of calculating a price in accordance with the pricing formula and the determined cost.

10. The method of claim 1, wherein the cost determination data comprises at least one indicator for selecting a cost determination formula used in the calculation of the determined cost.

11. The method of claim 2, wherein:
the price formula datastream contains data corresponding to a (i) predetermined identifiers representative of the condition table and the condition types, and (ii) the values associated with each of the condition types; and
the determined cost datastream contains data corresponding to the at least one determined cost.

12. The method of claim 1, wherein the step of receiving the first input is from a user and includes providing a branching logic query and user interface for eliciting at least one pricing requirement from the user.

13. The method of claim 1, wherein the at least one cost data comprises AP Cost, PO Cost, Market Cost, Model Cost, and Guaranteed Cost.

14. The method of claim 1, wherein the transaction data includes at least one of the following: order reason; sales order number; sales order line items; sales unit; order quantity; invoice quantity; net weight; currency; sales associate; gross price; cost of goods sold; purchase order type; freight costs; or geographic area.

15. The method of claim 1, wherein the at least one dynamic market value includes one of the following: an order reason; a sales order number; sales order line items; a sales unit; order quantity; invoice quantity; net weight; currency; a sales associate; gross price; cost of goods sold; a purchase order type; freight costs; or geographic area.

16. A system for associating and integrating price components into a pricing subsystem of an enterprise resource planning system for execution by a pricing execution engine of the pricing subsystem, the system comprising:
at least one computer having at least one processor adapted to execute computer executable modules and a memory coupled to the at least one processor, wherein the memory of the at least one computer comprises at least one computer executable module, which, when executed by the processor, causes the processor to:
(a) receive a first input including pricing requirements corresponding to goods sold, wherein the first input is incompatible with the pricing subsystem;
(b) receive a second input including one or more cost data;
(c) receive transaction data corresponding to at least one dynamic market value affecting price of the goods sold;
(d) determine at least one coefficient based on the transaction data;
(e) convert the pricing requirement into at least one surcharge and at least one discount;
(f) derive a pricing formula for calculating a price at the time of execution of the pricing formula, wherein the pricing formula comprises the coefficient times the cost of the goods sold, plus the at least one surcharge, and less the at least one discount;
(g) associate the pricing formula with a first identifier representative of a condition table in the pricing subsystem;
(h) associate the coefficient, the at least one surcharge, and the at least one discount with a second identifier representative of a condition type in the pricing subsystem;
(i) create price determination data and cost determination data; and
(j) transmit the cost determination data and the price determination data to the enterprise resource planning system for storage within a database associated with the enterprise resource planning system.

17. The system of claim 16, further comprising:
a second computer having at least one processor adapted to execute computer executable modules and a memory coupled to the at least one processor of the second computer, wherein the second computer is communicatively coupled to the at least one computer and the memory of the second computer comprises at least one computer executable module, which, when executed by the processor of the second computer, causes the processor of the second computer to:
calculate the determined cost based on the cost data and the cost determination data stored within the database associated with the enterprise resource planning system;
transmit a determined cost datastream to the pricing subsystem;
transform the price determination rule into a price formula datastream; and
transmit the price formula datastream to the pricing subsystem.

18. A computer-readable storage medium storing computer-executable instructions that, when executed, cause a computer system to perform a method for associating and integrating price components into a pricing subsystem of an enterprise resource planning system for execution by a pricing engine of the pricing subsystem, said method comprising:
(a) receiving a first input from a user including pricing requirements corresponding to goods sold by a third-party, wherein the first input is incompatible with the pricing subsystem;
(b) receiving a second input including one or more cost data;
(c) receiving transaction data corresponding to at least one dynamic market value affecting price of the goods sold;
(d) determining at least one coefficient based on the transaction data;
(e) converting the pricing requirements into at least one surcharge and at least one discount;
(f) deriving a pricing formula for calculating a price at the time of execution of the pricing formula, wherein the pricing formula comprises the coefficient times the cost of the goods sold, plus the at least one surcharge, and less the at least one discount;
(g) associating the pricing formula with a first identifier representative of a condition table in the pricing subsystem;
(h) associating the coefficient, the at least one surcharge, and the at least one discount with a second identifier representative of a condition type in the pricing subsystem;
(i) creating price determination data and cost determination data; and
(j) transmitting the cost determination data and the price determination data to the enterprise resource planning system for storage within a database associated with the enterprise resource planning system.

19. The computer-readable storage medium of claim 18, storing computer-executable instructions that, when executed, cause the computer system to further perform the method comprising:
calculating the determined cost based on the cost data and the cost determination data stored within the database associated with the pricing subsystem;
transmitting a determined cost datastream to the pricing subsystem;
transforming the price determination data into a price formula datastream; and
transmitting the price formula datastream to the pricing subsystem.
